(19) United States
(12) Patent Application Publication
(10) Pub. No.: US 2020/0142554 A1
(43) Pub. Date: May 7, 2020

(54) PAGE NAVIGATION IN DESKTOP LAUNCHER

(71) Applicant: MICROSOFT TECHNOLOGY LICENSING, LLC, Redmond, WA (US)

(72) Inventors: Gang LIN, Redmond, WA (US); Jiaxing HUANG, Redmond, WA (US); Yingdi SUN, Redmond, WA (US)

(73) Assignee: MICROSOFT TECHNOLOGY LICENSING, LLC, Redmond, WA (US)

(21) Appl. No.: 16/626,415

(22) PCT Filed: Jun. 27, 2017
(86) PCT No.: PCT/CN2017/090372

§ 371 Date: Dec. 24, 2019

(51) Int. Cl. G06F 3/0483; G06F 3/0482; G06F 3/0488

(52) U.S. Cl. CPC G06F 3/0483; G06F 3/04883; G06F 3/0482

(57) ABSTRACT

A method for page navigation is disclosed. A first page is presented on a display screen, a first input indicating a page moving in a first direction is received on the first page, presentation of the first page is switched to presentation of a second page, a second input indicating a page moving in a second direction is received on the second page, wherein the second direction is not collinear to the first direction, and presentation of the second page is switched to presentation of a third page.

### BACKGROUND

A desktop launcher provides a user interface (UI) for a user as a start point to operate at a computing device. For example, a launcher provides shortcuts to application programs in some pages of the UI, so that the user may start the application programs by operating the shortcuts on the pages. Examples of a mobile device launcher include open-sourced Android launcher, default launcher from iOS device or Windows Phone (WP) device.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure provide an improved launcher. In a method for page navigation in the launcher, a first page is presented on a display screen, a first input indicating a page moving in a first direction is received on the first page, presentation of the first page is switched to presentation of a second page, a second input indicating a page moving in a second direction is received on the second page, wherein the second direction is not collinear to the first direction, and presentation of the second page is switched to presentation of a third page.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary environment where the described techniques can be implemented.

FIGS. 2-7E each illustrates an exemplary part of a UI of a launcher according to an embodiment.

FIG. 8 is a flowchart of an exemplary method for page navigation according to an embodiment.

FIG. 9 illustrates an exemplary apparatus for page navigation according to an embodiment.

FIG. 10 illustrates an exemplary computing system according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

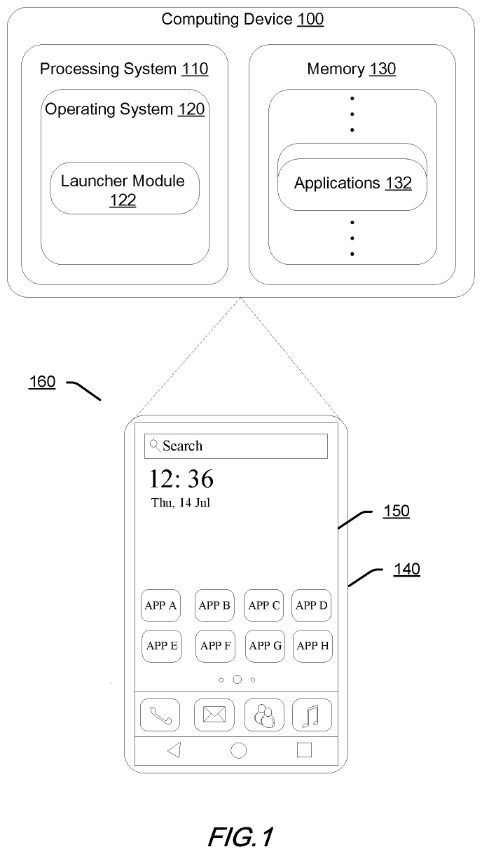

FIG. 1 illustrates an exemplary environment where embodiments of the disclosure can be implemented. It is to be appreciated that the structure and functionality of the environment are described only for the purpose of illustration without suggesting any limitations as to the scope of the disclosure. The disclosure can be embodied with a different structure or functionality.

The illustrated environment includes a computing device 100, which is illustrated as a mobile computing device (e.g., a mobile phone) having a housing 140. A variety of other configurations of the computing device 100 are also contemplated. For example, the computing device 100 may be configured as a traditional computer (e.g., a desktop personal computer, laptop computer, and so on), a mobile station, an entertainment appliance, a wireless phone, a tablet, a netbook, and so forth. Thus, the computing device 100 may range from full resource devices with substantial memory and processor resources to a low-resource device with limited memory and/or processing resources. The computing device 100 may also relate to software that causes the computing device 100 to perform one or more operations.

The computing device 100 is also illustrated as including a displayer 150, a processing system 110, and an example of computer-readable storage media, which in this instance is memory 130. The memory 130 is configured to maintain applications 132 that are executable by the processing system 110 to perform one or more operations.

The processing system 110 is not limited by the materials from which it is formed or the processing mechanisms employed therein. For example, the processing system 110 may be comprised of semiconductor(s) and/or transistors (e.g., electronic integrated circuits (ICs)), such as a system on a chip, processors, central processing units, processing cores, functional blocks, and so on. In such a context, executable instructions may be electronically-executable instructions. Alternatively, the mechanisms of the processing system 110, and thus of the computing device 100, may include, but are not limited to, quantum computing, optical computing, mechanical computing (e.g., using nanotechnology), and so forth. Additionally, although a single memory 130 is shown, a wide variety of types and combinations of memory may be employed, such as random access memory (RAM), hard disk memory, removable medium memory, and other types of computer-readable storage media.

The computing device 100 is further illustrated as including an operating system 120. The operating system 120 is configured to abstract underlying functionality of the computing device 100 to applications 132 that are executable on the computing device 100. For example, the operating system 120 may abstract the processing system 110, memory 130, network, input/output, and/or display functionality of the displayer 150, and so on such that the applications 132 may be written without knowing how this underlying functionality is implemented. The application 132, for instance, may provide data to the operating system 120 to be rendered and displayed by the displayer 150 without understanding how this rendering will be performed. The operating system 120 may also represent a variety of other functionality, such as to manage a file system and user interface that is navigable by a user of the computing device 100.

The operating system 120 may be configured to process a variety of different input/output functionality supported by the computing device 100. Thus, the operating system 120 include functionality relating to recognition of inputs and/or provision of outputs by the computing device 100 as well as devices used to detect those inputs. For example, the operating system 120 may be configured to identify gestures and cause operations to be performed that correspond to the gestures, and so on. The inputs may be detected for processing by the operating system 120 in a variety of different ways. For example, the operating system 120 may be configured to receive one or more inputs via touch interaction with a hardware device, e.g., fingers of a user's hand detected using touchscreen functionality of the displayer 150, via a natural user interface (NUI) with an image capturing device (e.g., a camera), via a cursor control device (e.g., a mouse), a remote control (e.g. a television remote control), and so on.

The operating system 120 may also represent a variety of other functionality, such as to manage a file system and a UI that is navigable by a user of the computing device 100. An example of this is illustrated as a launcher module 122 that is representative of functionality to implement a desktop launcher, an example of which is illustrated as a start screen or a home screen which provides a UI, that is, a desktop, for accessing applications or contents represented by the icons. Various configurations are contemplated, such as a desktop or UI that include a single screen on a display area of the displayer or include multiple screens which are switchable on the display area of the displayer. It should be appreciated that the term “screen” used in the context of the launcher UI is also referred to as “page”. It should be appreciated that the terms launcher, desktop, and UI may be utilized interchangeably in some contexts. And it should be appreciated that although the launcher module 122 is shown as implemented or integrated in the operating system 120, it's also possible to implement a launcher as an application 132, i.e., a launcher application may be executed at the computing device 100 to provide the desktop or UI 160.

The launcher 160, which may also be referred to as the UI 160 of the launcher, includes representations of a plurality of the applications or content 132, such as icon, tiles, textual descriptions, and so on, includes executable widgets, and may be configured in a variety of ways. The launcher 160, for instance, may be configured as a root level of a hierarchical file structure, e.g., each of the other levels are beneath the root level in the hierarchy. The representations shown in the illustrated example are selectable to launch a corresponding one of applications 132 for execution on the computing device 100. In this way, a user may readily navigate through a file structure and initiate execution of applications 132 of interest. Other configurations are also contemplated, examples of which are discussed in the following and shown in corresponding figures.

Output of the launcher 160 may be initiated in a variety of ways. In the illustrated example, the launcher 160 is initiated once the computing device 100 and the operating system 120 are turned on. In another example, a launcher application 132 may be executed at the computing device 100 to provide the UI of the launcher application 132. In this way, the UI of the launcher application 132 may replace the UI of the launcher integrated in the operating system 120.

It is illustrated that a home page of the UI of the launcher 160 includes various components such as a search box at the top of the UI, time and date, and icons “APP A” to “APP H” representing respective applications, three small circles, icons of applications denoted by shapes of telephone, envelope, human, and musical note, and operation symbols denoted by a triangle, a circle and a square. It should be appreciated that the icons of applications may be in various forms in addition to the illustrated text “APP A” to “APP H”, the graph shapes. The text “APP A” to “APP H” just represents the name of the applications that are installed at the computing device 100, but does not refer to the order of the applications. The three small circles indicate that there are three pages currently in the UI of the launcher, the bigger circle in the middle indicates the relative position of the current page among the three pages. The display area of the displayer 150 is also referred to as display screen herein for sake of simplicity. The square symbol denotes a home key, which, whenever pressed, causes the returning to the home page, that is, the home page is presented in the display screen 150 whenever the home key is pressed. The triangle symbol denotes a backward key, which, when pressed, causes the returning to the previous interface. The square symbol denotes some special function, for example, the icons of executing applications may be presented when the square symbol is pressed. It should be appreciated that the UI of the launcher 160 is just an example, and the present disclosure is not limited thereto.

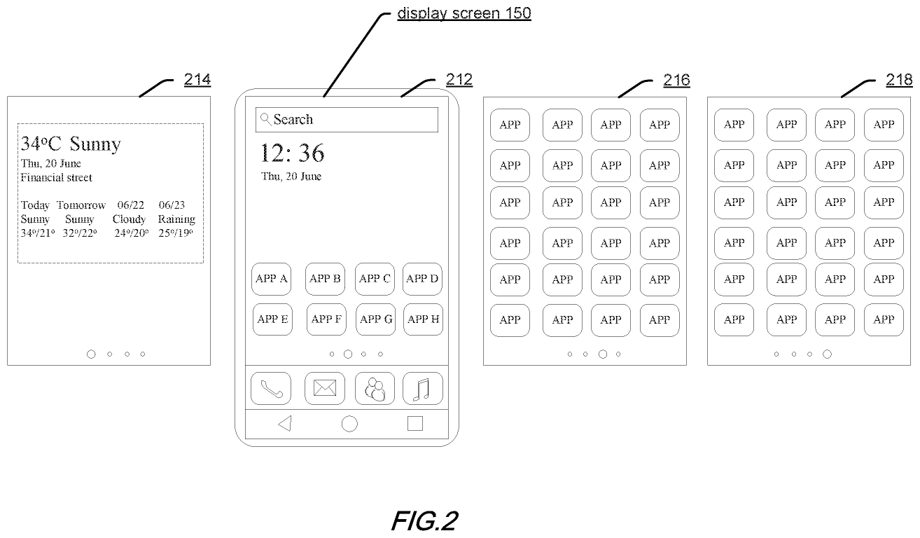

FIG. 2 illustrates an exemplary structure of page arrangement of a launcher according to an embodiment. The same label numbers in different Figures refer to same or corresponding elements.

A home page 212 of the launcher is presented on the display screen 150. Although the labels 150 and 212 are directing to the same block because the display screen and the page presented on display screen are overlapped in the figure, the difference between the display screen and the page presented thereon should be apparent for those skilled in the art.

The launcher includes four pages 212 to 218, where the page 212 is a home page, which may be presented whenever the home key denoted by the circle is pressed, the page 214 includes a widget related to weather, the pages 216 and 218 include icons of applications. It should be appreciated that one page may include various contents such as application icons, widgets or the like.

The four pages 212 to 218 may be horizontally switched so as to interchangeably present on the display screen 150. For example, a rightwards swipe operated on the presented page 212 may allow another page 214 at its left side to be presented on the display screen 150, a leftwards swipe operated on the presented page 212 may allow another page 216 at its right side to be presented on the display screen 150, and then, a leftwards swipe operated on the presented page 216 may allow another page 218 at its right side to be presented on the display screen 150.

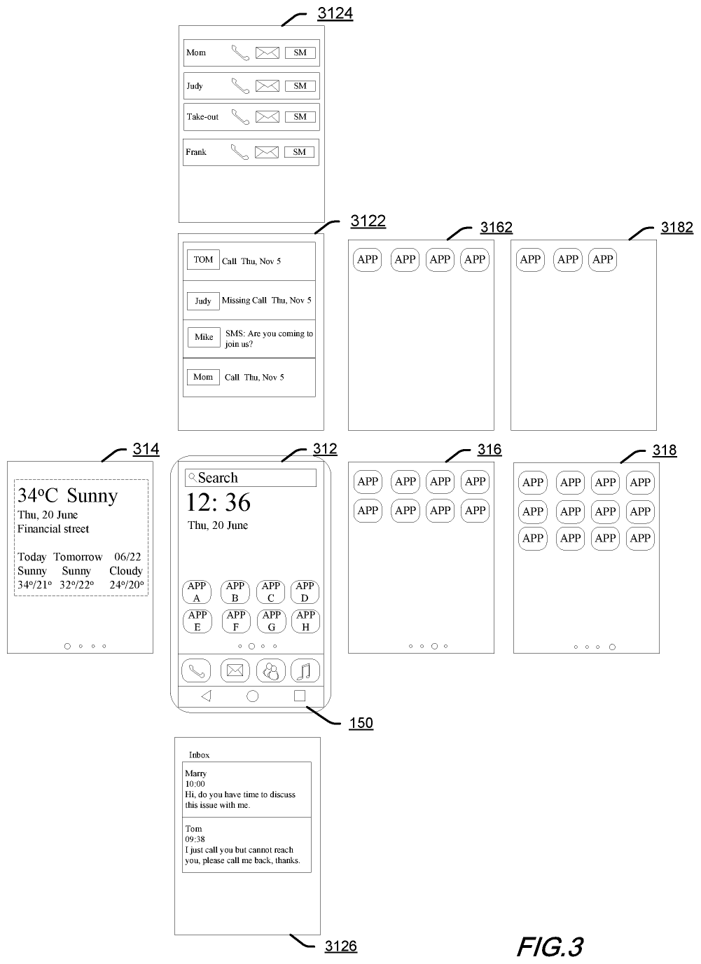

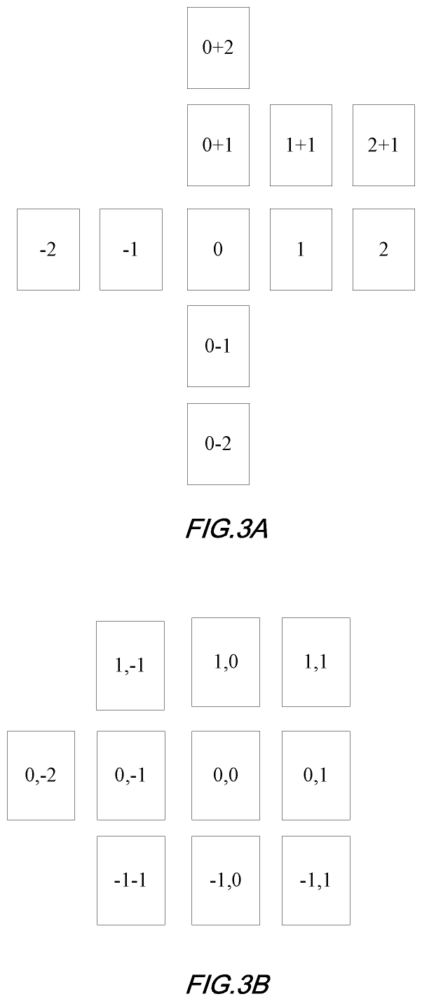

FIG. 3 illustrates an exemplary structure of page arrangement of a launcher according to an embodiment.

A home page 312 of the launcher is currently presented on the display screen 150. The launcher includes four pages 312 to 318 arranged in the horizontal direction relative to the computing device or the display screen 150, includes three pages 3122 to 3126 which, together with home page 312, are arranged in the vertical direction relative to the display screen 150, includes a page 3162 which, together with page 316, are arranged in the vertical direction relative to the display screen 150, and includes a page 3182 which, together with page 318, are arranged in the vertical direction relative to the display screen 150.

The multiple pages arranged in two dimensions may be horizontally and vertically switched so as to interchangeably present on the display screen 150. For example, a leftwards swipe operated on the presented page 312 may allow another page 316 at its right side to be presented on the display screen 150, and an upwards swipe operated on the presented page 312 may allow another page 3126 at its underside to be presented on the display screen 150.

In the exemplary implementation as illustrated in FIG. 3, the page 3122 at the upside of the page 312 includes a widget for providing recent communications, and the next upper page 3124 includes a widget for providing preferred contacts or frequent contacts, the page 3126 at the downside of the page 312 includes a widget related to mailbox. Therefore, the user may reach the frequently used content such as the recent communications and the mailbox by one swipe upwards or downwards operation from the home page 312. Moreover, similar functions or contents may be organized in the same column of pages in the vertical direction, for example, the frequently reviewed widgets may be arranged in this column of pages, so that the user is allowed to reach the frequently reviewed widgets in the specific column of pages.

Similarly, applications may be organized efficiently by using the illustrated structure of page navigation. For example, the page 316 may be used to organize a category of applications such as application related to messaging, and the page 3162 at the upside of the page 316 may be used to put a widget of a messaging application so that the message may be reviewed quickly by swiping to the page 3162 without opening the messaging application, or the page 3162 may be used to put some private messaging applications such as dating applications so that the private messaging application may be protected by, for example, setting a passkey for the page 3162. In another example, the frequently used messaging apps may be put on the page 316 because the page 316 is nearer to the home page, and other messaging applications may be put on the upper page 3162, so that the frequently used messaging applications may be located easily at the page 316 and the other messaging applications may be found at the upper page 3162 of the same column.

Although exemplary organizations of the applications and widgets on the pages are illustrated, it should be appreciated that the disclosure is not limited to the specific organizations of the contents on the pages. The page navigation structure proposed in the disclosure essentially improves the efficiency of content organization on the basis of pages in the launcher.

FIG. 3A illustrates an exemplary configuration of pages in a launcher according to an embodiment.

As illustrated, the pages, which are arranged in the same line with the home page in the horizontal direction, are defined as main page. Pages above or below each main page are defined as subpages. The home page is denoted as the main page 0, main pages on the right side of the home page are denoted as main page +1, +2, etc, main pages on the left side of home page are denoted as main page −1, −2, etc.

For a specific Main Page N, the pages above it are defined as subpages +1, +2, etc of Main Page N, denoted as N+1, N+2, etc, and pages below it are defined as subpages −1, −2, etc of Main Page N, denoted as N−1, N−2, etc. Examples of the main pages include the pages 312, 314, 316 and 318 shown in FIG. 3, and examples of the subpages include the pages 3122, 3124, 3126, 3162 and 3182 at the upside and downside of the main pages shown in FIG. 3.

In this exemplary configuration, the subpages depend on the corresponding main page and originate from the main page. Specifically, only after a main page is created, its subpages can be created on the basis of the main page. This configuration takes advantages of the subpages to implement various functions and efficient organization of contents on the basis of main pages.

FIG. 3B illustrates an exemplary configuration of pages in a launcher according to an embodiment.

The pages in the launcher are denoted as two dimensional (2D) pages (m, n), where the home page is denoted as page (0, 0). An exemplary implementation of this configuration is a 3×3 page matrix, which is specially efficient for the switching from the home page to each of the other eight pages, that is, any of the eight pages may be reached from the home page by one swiping. It should be appreciated that this configuration is not limited to the 3×3 page matrix, any form of 2D page arrangement in the launcher may be implemented. Examples of the pages (0,−2) to (0, 1) include the pages 312, 314, 316 and 318 shown in FIG. 3, and examples of the other pages shown in FIG. 3B include the pages 3122, 3124, 3126, 3162 and 3182 shown in FIG. 3.

In either of the configurations, the home page can be presented on the display screen whenever the home key is pressed. It should be appreciated that, the page navigation illustrated in FIG. 3 can be implemented with either of the configurations illustrated in FIGS. 3A and 3B.

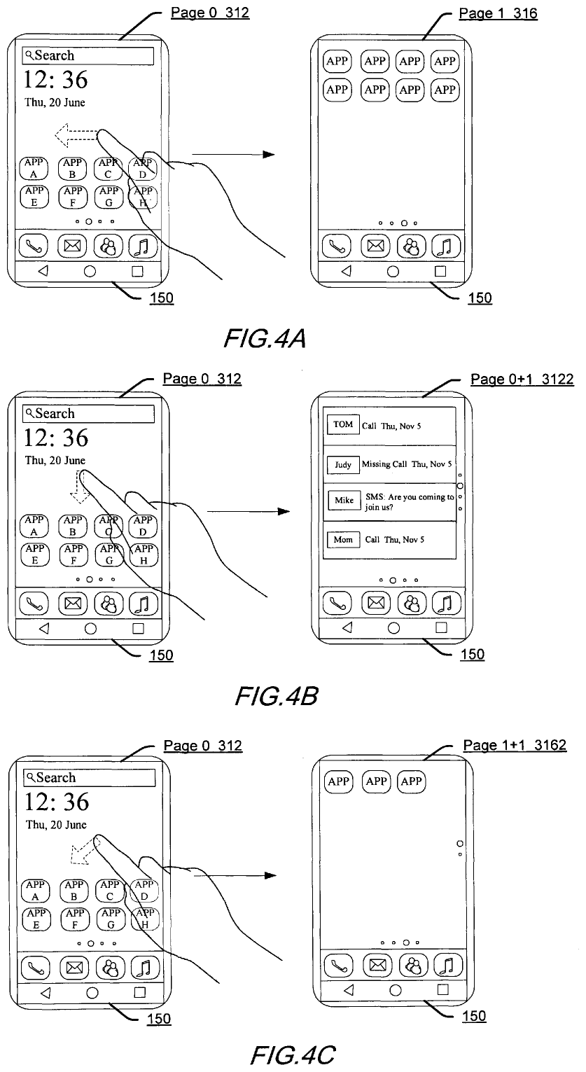

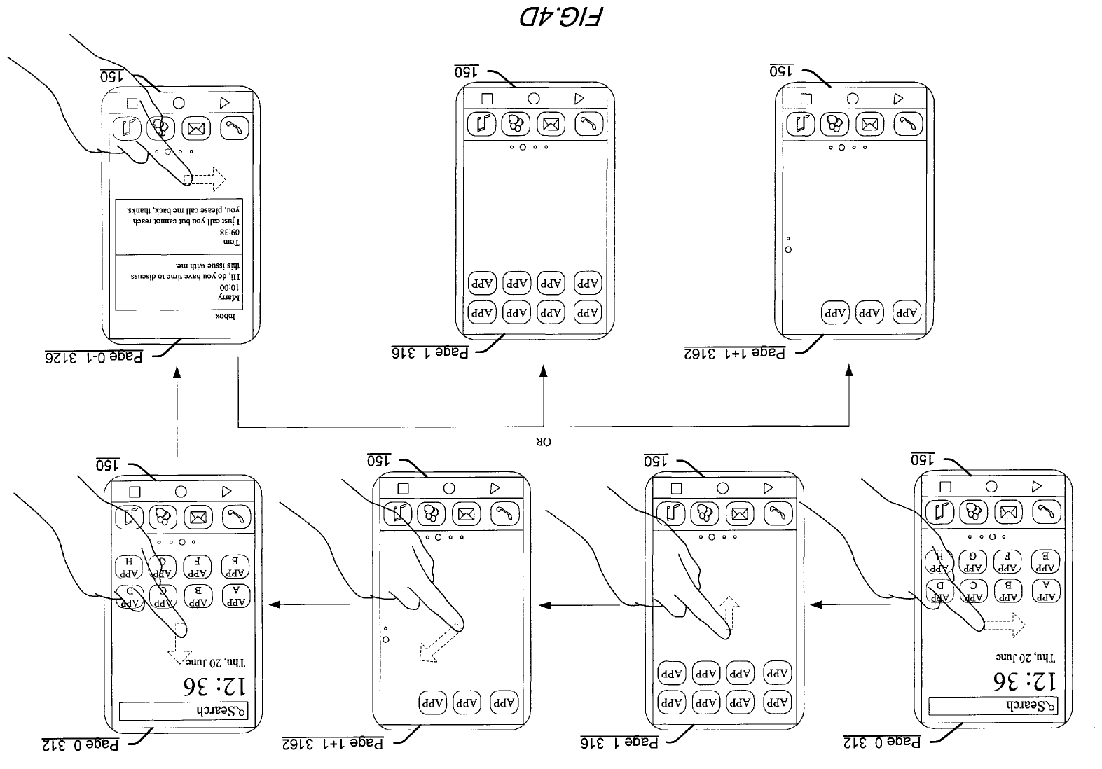

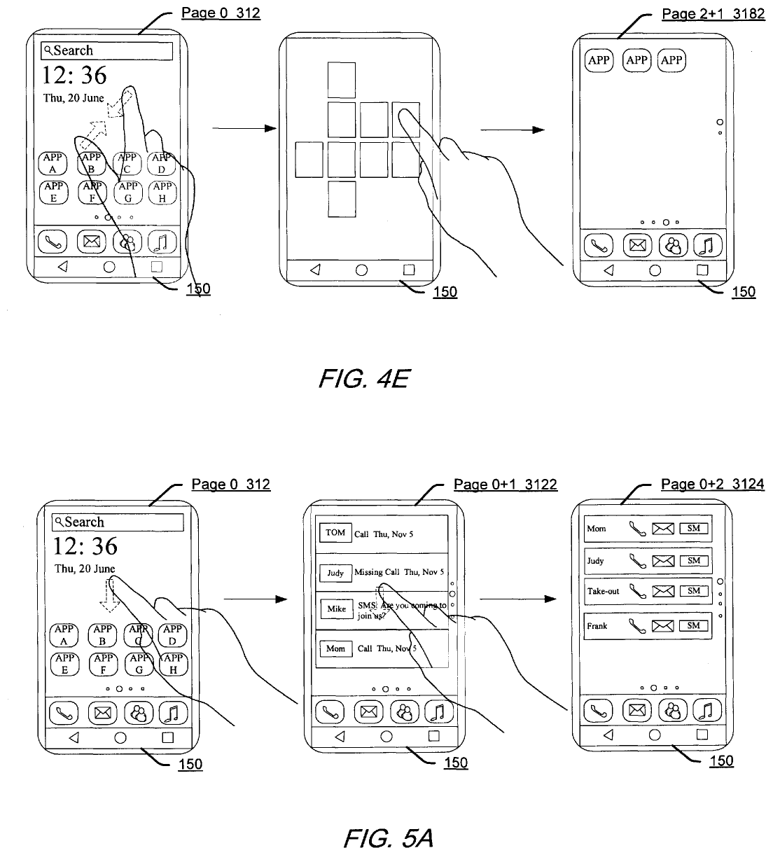

FIGS. 4A-4E each illustrates exemplary page navigation in a launcher according to an embodiment. The exemplary page navigation is illustrated on the basis of the exemplary page arrangement shown in FIG. 3, and the same label numbers are used for the same elements.

As illustrated in FIG. 4A, a page such as the home page 0 312 is currently presented on the display screen, and an input indicating a page moving to the left is received on the display screen (such a status is described in the disclosure as an input indicating a page moving to the left is received on the presented page, in order to indicates the starting page of the switching in a simple way). When the input indicating a page moving to the left is received on the presented page, the presentation of the page 0 312 is switched to the presentation of the page 1 316 at the right side of the page 0 312. The input indicating the page moving is a leftwards swipe of a finger on the presented page. It should be appreciated that a rightwards swipe on the presented page may cause the left page −1 314 to be presented on the display screen instead of the current page 0 312. Either the left direction or the right direction belongs to the horizontal direction.

As illustrated in FIG. 4B, currently a page such as the home page 0 312 is presented on the display screen. When an input indicating a page moving downwards is received on the presented page, the presentation of the page 0 312 is switched to the presentation of the page 0+1 316 at the upside of the page 0 312. The input indicating the page moving is a downwards swipe of a finger on the presented page. It should be appreciated that an upwards swipe input on the presented page may cause the underside page 0−1 3126 to be presented on the display screen instead of the current page 0 312. Either the upwards direction or the downwards direction belongs to the vertical direction.

The four small circles along the bottom side of the page indicate that there are four main pages in the UI of the launcher, the bigger circle indicates the relative position of the current main page among the four main pages. The four small circles along the right side of the page indicate that there are four pages in the current page column, and the bigger circle indicates the relative position of the current subpage among the four pages in the column. The circles along the right side of the page may be only presented in a subpage, or may also be presented in a main page.

As illustrated in FIG. 4C, currently a page such as the home page 0 312 is presented on the display screen. When an input indicating a page moving to the left-down direction is received on the presented page, the presentation of the page 0 312 is switched to the presentation of the page 1+1 3162 at the up-right side of the page 0 312. The input indicating the page moving is a finger swipe to the left-down direction on the presented page. It should be appreciated that swipes in such an oblique direction such as left-up direction, right-up direction and right-down direction may cause similar switching of page presentation.

As illustrated in FIG. 4D, currently a page such as the home page 0 312 is presented on the display screen. When an input indicating a page moving to the left, such as a finger leftwards swipe, is received on the presented page, the presentation of the page 0 312 is switched to the presentation of the page 1 316 at the right side of the page 0 312.

Then, when an input indicating a page moving downwards, such as a finger downwards swipe, is received on the presented page 1 316, the presentation of the page 1 316 is switched to the presentation of the page 1+1 3162 at the upside of the page 1 316.

Then, when an input indicating a page moving to the right-up direction, such as a finger swipe in the right-up direction, is received on the presented page 1+1 3162, the presentation of the page 1+1 3162 is switched to the presentation of the page 0 312 at the left-down side of the page 1+1 3162.

Then, when an input indicating a page moving upwards, such as a finger upwards swipe, is received on the presented page 0 312, the presentation of the page 0 312 is switched to the presentation of the page 0−1 3126 at the downside of the page 0 312.

Then, when an input indicating a page moving leftwards, such as a finger leftwards swipe, is received on the presented page 0−1 3126, the operations may be different in different implementations. In an implementation, the presentation of the presented subpage 0−1 3126 is switched to the presentation of the subpage 1+1 3162, which is the last presented page in the column of pages at the right side of the page 0−1 3126. In another implementation, the presentation of the presented subpage 0−1 3126 is switched to the presentation of the main page 1 316, no matter whether it is the last presented page in the column of pages at the right side of the page 0−1 3126. In another implementation, for the specific 3*3 page matrix as illustrated in FIG. 3B, the relative positions of the pages in the 3*3 page matrix remains unchanged, and thus a leftwards swipe operated on the page (−1,0) leads to the switching from the presentation of the page (−1,0) to its always right page (−1,1). It should be appreciated that there may be other possible page navigation ways on the basis of the 2D page arrangement in the launcher.

FIG. 4E illustrates an exemplary navigation of page according to an embodiment.

When an input indicating a point-navigation mode is received on the display screen, no matter which page is currently presented, the small representations of all the pages are presented. The input may be a special finger gesture operated on the touch screen, such as two fingers moving towards to each other as shown in the FIG. 4E. After the user points one of the small representations, the page corresponding to the pointed small representation is presented in the display screen. In the illustrated example, the navigation from the home page 0 312 to the faraway page 2+1 3182 may be performed quickly by using the point-navigation mode. It should be appreciated that the small representations of the pages may be presented in a scrollable screen, which may be scrolled in the vertical and horizontal directions.

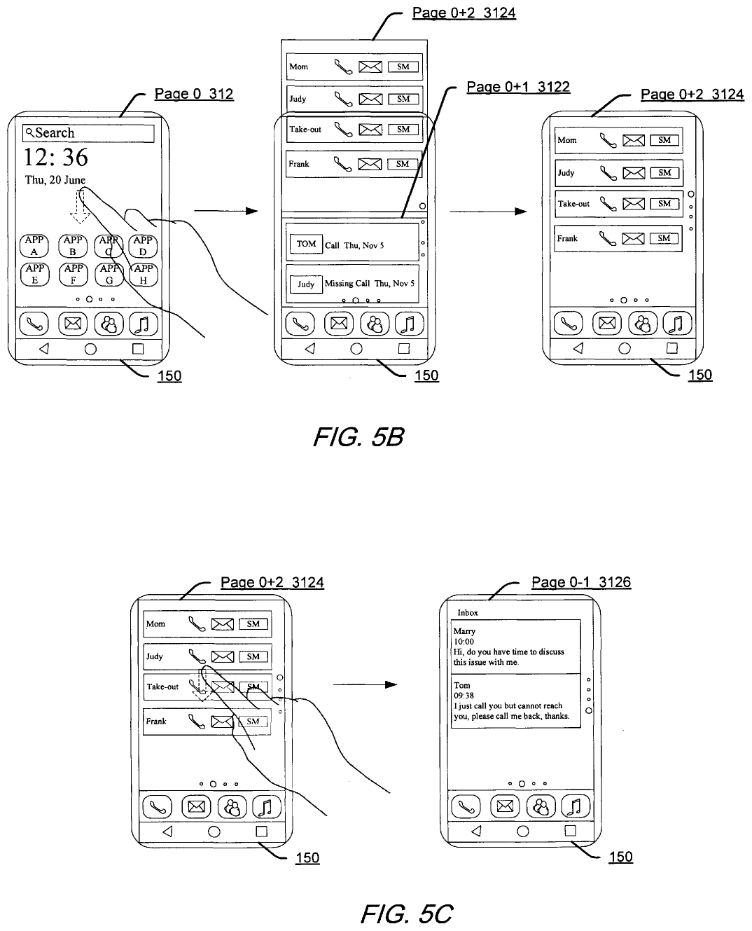

FIG. 5A illustrates a page-by-page switching mode of a column of pages in the vertical direction according to an embodiment.

When an input indicating a page moving downwards, such as a finger downwards swipe, is received on the presented page 0 312, the presentation of the page 0 312 is switched to the presentation of the page 0+1 3122 at the upside of the page 0 312. Then, when an input indicating a page moving downwards, such as a finger downwards swipe, is received on the presented page 0+1 3122, the presentation of the page 0+1 3122 is switched to the presentation of the page 0+2 3124 at the upside of the page 0+1 3122. For each swipe, the moving of pages stops at exact one of the pages, in other words, the moving of pages does not stop between two pages, so that the pages are presented one by one on the display screen 150.

In some implementations, the page 0+1 3122 may be a scrollable page. The contents included in the page 0+1 3122 cannot be presented all together in the display screen, and thus this page 0+1 3122 may be scrolled to present the contents in the page. In the page-by-page switching mode of a column of pages, for example, when the presentation of the page 0 312 is switched to the scrollable page 0+1 3122, the scrollable page 0+1 3122 may be initially presented at the page starting part, then the user may scroll the page to view the contents within the page. As illustrated in FIG. 5A, when the user swipes downwards at the status of the top portion of the scrollable page is presented, the presentation of the scrollable page 0+1 3122 is switched to the presentation of the page 0+2 3124 at the upside of the page 0+1 3122. Similarly, when the user swipes upwards at the status of the bottom portion of the scrollable page 0+1 3122 is presented, the presentation of the scrollable page is switched to the presentation of the page 0 312 at the downside of the page 0+1 3122.

It should be appreciated that any page, either a main page or a subpage, may be a scrollable page in order to accommodate more contents in one page. The navigation among pages including one or more scrollable pages is similar to the navigation among non-scrollable pages, and the disclosure is applicable to navigation among pages including one or more scrollable pages.

FIG. 5B illustrates a continuous scrolling mode of a column of pages in the vertical direction according to an embodiment. When an input indicating a page moving downwards, such as a finger downwards swipe, is received on the presented page 0 312, the presentation of the column of pages may be scrolled downwards continuously and stop between two pages such as between the page 0+1 3122 and the page 0+2 3124. Taking advantage of the continuous scrolling mode of pages, more than one page may be passed by one swipe according to the speed and distance of the swipe relative to the touch screen, therefore the switching from a first page to a second page which is located several pages away from the first page may be achieved by less swipes quickly. Then, after a small swipe downwards on the display screen, the page 0+2 3124 may be presented at the display screen.

FIG. 5C illustrates a cyclic switching mode of a column of pages in the vertical direction according to an embodiment. Continuing from the presented page 0+2 3124 shown in FIG. 5A, which is the top page in the column of pages, when an input indicating a page moving downwards, such as a finger downwards swipe, is received on the presented page 0+2 3124, the presentation of the page 0+2 3124 is switched to the presentation of the page 0−1 3126 at the downside of the home page 0 312. This cyclic switching mode allows the user to review all the column of pages by swiping in one direction.

The cyclic mode may be combined with either of the page-by-page mode and the continuous mode. And any of the three modes may be respectively set for each column of pages, in other words, different modes or mode combinations may set for different page columns in the launcher.

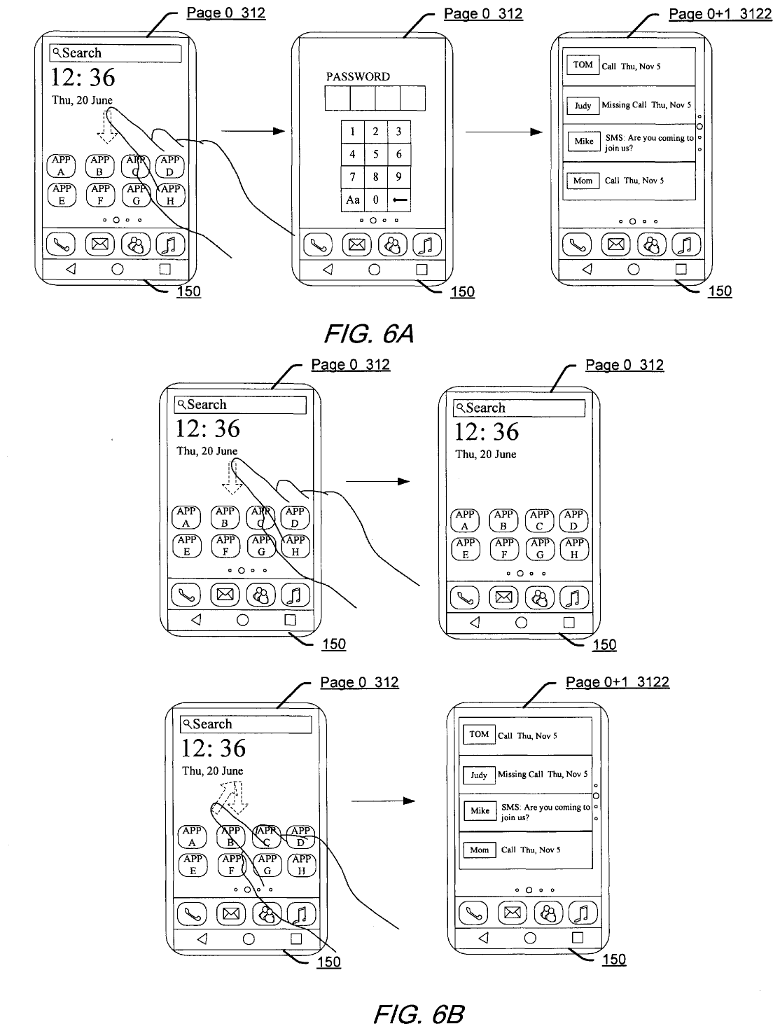

FIG. 6A illustrates an exemplary locking function of subpages according to an embodiment.

A password may be set for a main page such as the main page 0 312 to lock its subpages. As illustrated, when an input indicating a page moving downwards, such as a finger downwards swipe, is received on the main page 0 312, a password query interface is presented to request the user to input password. After receiving the password, the page 0+1 3122 is presented on the display screen. It should be appreciated that the passwords may be set for one or more of the main pages separately. Taking advantage of the locking function, the user is allowed to put private or secret content such as applications, widgets or other contents on the subpage, and may locate to the protected content conveniently on the subpage.

FIG. 6B illustrates an exemplary locking function of subpages according to an embodiment.

In a first implementation, the presentation of subpages of a main page may be manually disabled. For example, a setting interface may be provided to the user to disable the presentation of subpages for a specific main page. Under the disabling setting, when a user swipes upwards or downwards on the main page, its subpage is not presented after receiving the finger swipe even if the main page actually has subpages. On the other hand, the presentation of subpages of the main page may be manually enabled. For example, a setting interface may be provided to the user to enable the presentation of subpages for a specific main page. Under the enabling setting, the column of pages may be switched in response to user input such as the finger swipe on the vertical direction.

In a second implementation, a special gesture may be set for a main page such as the main page 0 312 to lock its subpages. Under this setting, when a user input which generally indicates a page moving upwards or downwards is received on a main page, the subpage of the main page would not be presented if the user input is different from the set special gesture, as illustrated in the upper side of the FIG. 6B. On the other hand, when a user input of the special gesture is received on the main page, the subpage is presented in the display screen. An example of the special gesture is illustrated in FIG. 6B, that is, swiping upwards and then downwards continuously.

In some implementations, the locking function, such as those illustrated above with reference to FIGS. 6A and 6B, may be automatically enabled or disabled based on time and/or location. For example, a setting interface may be provided for the user to set a specific time period during which the locking of subpages of a main page is enabled. The setting interface may also allow the user to set a specific location at which the locking of subpages of a main page is enabled. For example, a user does not want some application such as a Stock software to be accessed by other people in the working time, and the user may put the application on a subpage and set a period such as 9:00 to 17:00 during which the subpage is locked, either through a password, or through a special gesture, or completely disabled. On the other hand, the locked subpage is unlocked automatically outside the set time period. The user may also set a location such as his working building at which the subpage is locked. On the other hand, the launcher may automatically cancel the lock of the subpage when the launcher detects that the user is not at the location.

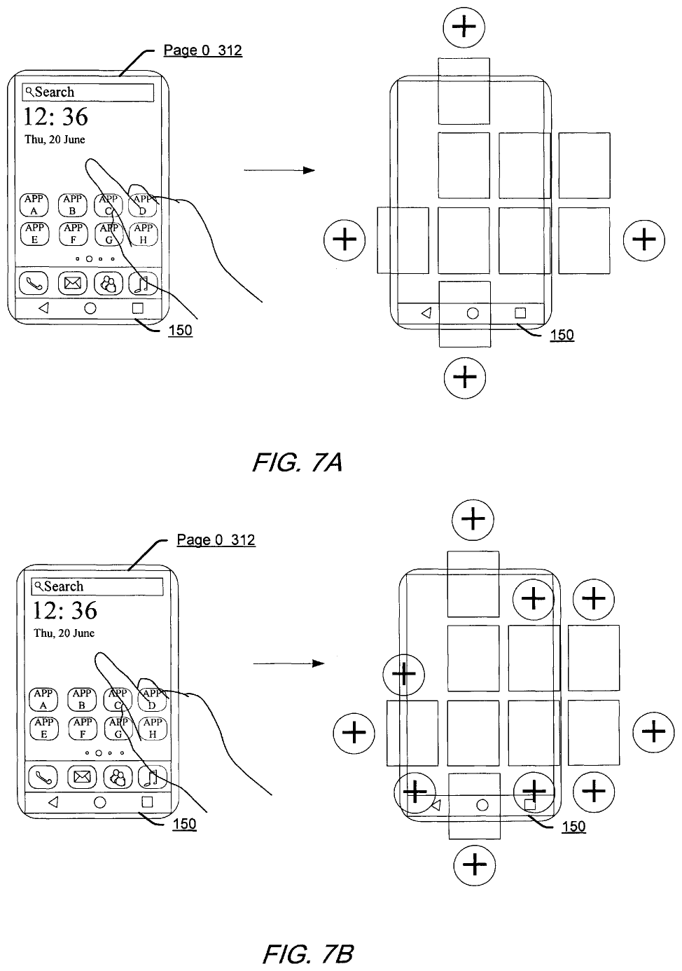

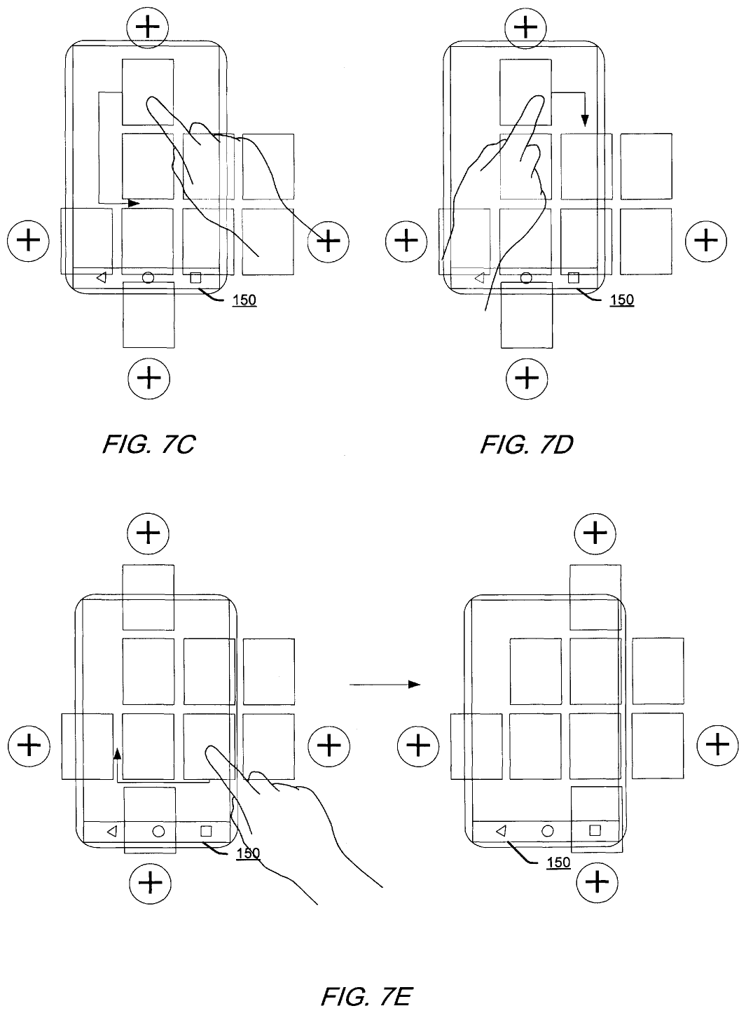

FIG. 7A illustrates an exemplary edit mode of pages in a launcher according to an embodiment.

An edit mode of pages in a launcher may be entered, for example, when a user is pressing the screen over a predefined time period. As illustrated, when the user presses on the main page 0 312 to enter the edit mode, two main page adding symbols are presented at the two ends of the main page line and two subpage adding symbols are presented at the two ends of the page column including the main page 0 312. A main page may be added by operating the main page adding symbol, and a subpage of the main page 0 312 may be added by operating the subpage adding symbol.

FIG. 7B illustrates an exemplary edit mode of pages in a launcher according to an embodiment.

An edit mode of pages in a launcher may be entered, for example, when a user is pressing the screen over a predefined time period. As illustrated, when the user presses on any page such the main page 0 312 to enter the edit mode, two main page adding symbols are presented at the two ends of the main page line and subpage adding symbols are presented at the two ends of each page column. A main page may be added by operating the main page adding symbol, and a subpage may be added by operating the subpage adding symbol.

Although it is illustrated exemplary edit modes for adding pages in the launcher, it should be appreciated that the specific ways for adding pages are various and the disclosure is not limited to any specific edit modes for adding pages.

FIGS. 7C-7E illustrates an exemplary adjustment of page order in a launcher according to an embodiment.

After entering the edit mode of pages in a launcher as illustrated in FIG. 7A, a subpage may be changed to another position in the column including the subpage, as illustrated in FIG. 7C. For example, a user finger may presses the subpage and drag it to another position among the column of pages.

In the editing mode of pages in the launcher, a subpage in a first column may be changed to another position in a second column, as illustrated in FIG. 7D. For example, a user finger may presses the subpage and drag it to another column of pages.

In the editing mode of pages in the launcher, a main page may be changed from its position in the main page line to another position in the main page line. As illustrated in FIG. 7E, when the position of the main page is changed, the whole page column is changed to the new position in the main page line.

Although it is illustrated exemplary operations for page position changing in the edit mode, it should be appreciated that the specific ways for changing page position are various and the disclosure is not limited to any specific ways for changing page position.

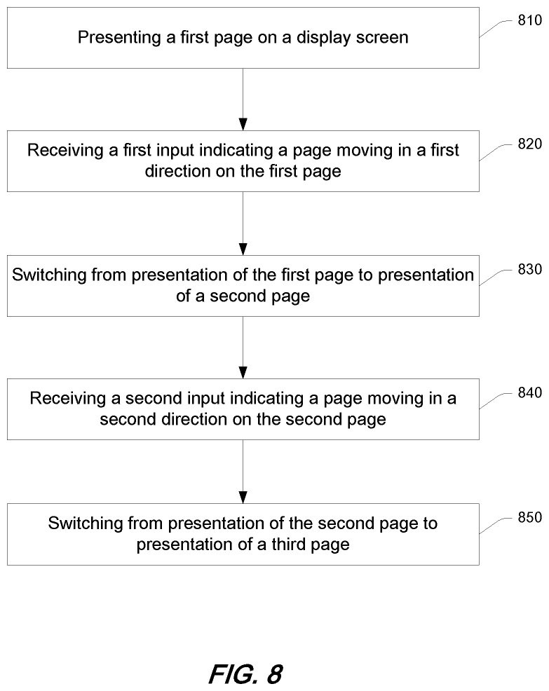

FIG. 8 illustrates an exemplary process for page navigation in a launcher according to an embodiment.

At 810, a first page is presented on a display screen. At 820, a first input indicating a page moving in a first direction is received on the first page. At 830, presentation of the first page is switched to presentation of a second page. At 840, a second input indicating a page moving in a second direction is received on the second page, wherein the second direction is not collinear to the first direction. It should be appreciated that the term “collinear” intends to define that the first direction and the second direction are not in the same line, or are not parallel to each other. For example, a left direction and a right direction are collinear to each other, a horizontal direction and a vertical direction are not collinear to each other. At 850, presentation of the second page is switched to presentation of a third page.

In an implementation, a third input indicating a page moving in a third direction is received on the third page, wherein the third direction is not collinear to either of the first direction and the second direction. Presentation of the third page is switched to presentation of a fourth page. The fourth page may be the first page or the fourth page may not be the first page.

In an implementation, the first direction is horizontal direction relative to the display screen, and the second direction is vertical direction relative to the display screen. In an implementation, the first direction is right or left direction relative to the display screen, and the second direction is up or down direction relative to the display screen, the third direction may be one of left-up direction, left-down direction, right-up direction, and right-down direction.

In an implementation, the first page is one of a plurality of main pages which can be presented interchangeably in the first direction on the display screen. The second page is one of the plurality of main pages. The third page is a subpage of the second page, wherein the second page and its subpages can be presented interchangeably in the second direction on the display screen.

In an implementation, the second page and its subpages can be presented cyclically in the second direction on the display screen.

In an implementation, the switching from presentation of the second page to presentation of the third page is performed in a continuous scrolling mode or in a page by page switching mode.

In an implementation, switching from presentation of the first page to presentation of a subpage of the first page is locked.

In an implementation, a password query interface is presented after an input indicating a page moving in the second direction is received on the first page, and presentation of the first page is switched to presentation of a subpage of the first page after receiving a correct password.

In an implementation, presentation of the first page is switched to presentation of a subpage of the first page after receiving a special gesture input on the first page, while presentation of the first page is not switched to presentation of a subpage of the first page after receiving on the first page a gesture input which generally indicates a page moving in the second direction but which is different from the special gesture.

In an implementation, switching from presentation of the first page to presentation of a subpage of the first page in the second direction is disabled.

In an implementation, switching from presentation of the first page to presentation of a subpage of the first page in the second direction is disabled automatically during a specific time period and/or at a specific location, and is enabled automatically outside the specific time period and/or the specific location.

In an implementation, small representations of all pages are presented, wherein the small representations are arranged in the first and second directions. A selection of one of the small representations is received. A page corresponding to the selected small representation is presented on the display screen.

In an implementation, at least one of the following is performed based on user input: entering an editing mode for pages; changing position of a page among pages; adding a page among pages; adding a main page in the first direction; adding a subpage of a main page in the second direction; changing position of a subpage of a main page among subpages of the main page; changing position of a subpage of a main page to a position among subpages of another main page; and changing position of a main page among a plurality of main pages, wherein positions of subpages of the main page are changed together with the main page.

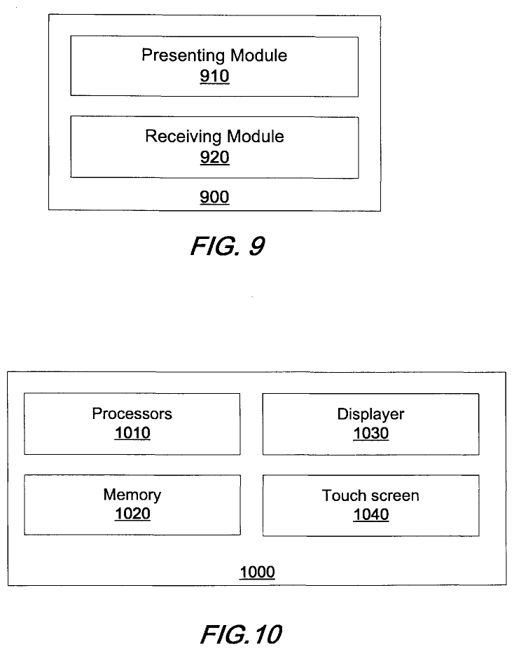

FIG. 9 illustrates an exemplary apparatus for page navigation in a launcher according to an embodiment.

The apparatus 900 includes a presenting module 910 and a receiving module 920. In an implementation, the presenting module 910 presents a first page on a display screen. The receiving module 920 receives a first input on the first page, the first input indicates a page moving in a first direction. The presenting module 910 switches from presentation of the first page to presentation of a second page. The receiving module 920 receives a second input on the second page, the second input indicates a page moving in a second direction, wherein the second direction is not collinear to the first direction. The presenting module 910 switches from presentation of the second page to presentation of a third page.

In an implementation, the receiving module 920 receives a third input on the third page, the third input indicates a page moving in a third direction, wherein the third direction is not collinear to either of the first direction and the second direction. The presenting module switches from presentation of the third page to presentation of a fourth page. The fourth page may be the first page or the fourth page may not be the first page.

In an implementation, the first direction is right or left direction relative to the display screen, and the second direction is up or down direction relative to the display screen, the third direction may be one of left-up direction, left-down direction, right-up direction, and right-down direction.

In an implementation, the first page is one of a plurality of main pages which can be presented interchangeably in the first direction on the display screen. The second page is one of the plurality of main pages. The third page is a subpage of the second page, wherein the second page and its subpages can be presented interchangeably in the second direction on the display screen.

In an implementation, the presenting module 910 presents the second page and its subpages cyclically in the second direction on the display screen.

In an implementation, the presenting module 910 switches from presentation of the second page to presentation of the third page in a continuous scrolling mode.

In an implementation, the presenting module 910 switches from presentation of the second page to presentation of the third page in a page by page switching mode.

In an implementation, the apparatus 900 includes a locking module. The locking module locks the switching from presentation of the first page to presentation of a subpage of the first page.

In an implementation, the locking module provides a password query interface after an input indicating a page moving in the second direction is received on the first page. The presenting module 910 switches presentation of the first page to presentation of a subpage of the first page after a correct password is received.

In an implementation, the presenting module 910 switches presentation of the first page to presentation of a subpage of the first page after a special gesture input is received on the first page. The presenting module 910 would not switch presentation of the first page to presentation of a subpage of the first page after receiving on the first page a gesture input which generally indicates a page moving in the second direction but which is different from the special gesture.

In an implementation, the locking module disables switching from presentation of the first page to presentation of a subpage of the first page.

In an implementation, the locking module disables switching from presentation of the first page to presentation of a subpage of the first page automatically during a specific time period and/or at a specific location, and enables the switching from presentation of the first page to presentation of a subpage of the first page automatically outside the specific time period and/or the specific location.

In an implementation, the presenting module 910 presents small representations of all pages, wherein the small representations are arranged in the first and second directions. The receiving module receives a selection of one of the small representations. The presenting module 910 presents a page corresponding to the selected small representation on the display screen.

In an implementation, the apparatus comprises an editing module. The editing module performs at least one of the following based on user input: entering an editing mode for pages; changing position of a page among pages; adding a page among pages; adding a main page in the first direction; adding a subpage of a main page in the second direction; changing position of a subpage of a main page among subpages of the main page; changing position of a subpage of a main page to a position among subpages of another main page; and changing position of a main page among a plurality of main pages, wherein positions of subpages of the main page are changed together with the main page.

The apparatus 900 may also comprise any other modules configured for performing any operations described above with reference to FIGS. 1-8.

FIG. 10 illustrates an exemplary system according to an embodiment.

The system 1000 may comprise one or more processors 1010. The system 1000 may further comprise a memory 1020 that is connected with the one or more processors 1010. The memory 1020 may store computer-executable instructions that, when executed, cause the one or more processors 1010 to run a desktop launcher. The system 1000 may further comprise a displayer 1030 for displaying a UI of the desktop launcher, the UI includes a plurality of pages that can be interchangeably presented on the displayer. The system 1000 may further comprise an input unit 1040 for receiving a user input via the UI. The input unit 1040 is illustrated as a touch screen 1040 in FIG. 10. It should be appreciated that any input unit may be applicable in the disclosure, for example, a cursor control device, a camera supporting a NUI, and so on. Although the touch screen 1040 is illustrated as a separate unit from the displayer, it's also possible to integrate the touch screen 1040 in the displayer 1030.

The computer-executable instructions, when executed, further cause the one or more processors 1010 to present a first page on the displayer; receive a first input on the first page, the first input indicates a page moving in a first direction; switch from presentation of the first page to presentation of a second page; receive a second input on the second page, the second input indicates a page moving in a second direction, wherein the second direction is not collinear to the first direction; and switch from presentation of the second page to presentation of a third page.

The computer-executable instructions, when executed, cause the one or more processors 1010 to perform any operations described above with reference to FIGS. 1-9.

The embodiments of the present disclosure may be embodied in a non-transitory computer-readable medium. The non-transitory computer-readable medium may comprise instructions that, when executed, cause one or more processors to perform any operations according to the embodiments as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors (e.g., cache or register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

1. A method for page navigation in a launcher, comprising:
presenting a first page on a display screen;
receiving a first input on the first page, wherein the first input indicates a page moving in a first direction;
switching from presentation of the first page to presentation of a second page;
receiving a second input on the second page, wherein the second input indicates a page moving in a second direction, wherein the second direction is not collinear to the first direction; and
switching from presentation of the second page to presentation of a third page.

2. The method of claim 1, further comprising
receiving a third input on the third page, wherein the third input indicates a page moving in a third direction, wherein the third direction is not collinear to either of the first direction and the second direction; and
switching from presentation of the third page to presentation of a fourth page, wherein the fourth page is the first page or the fourth page is not the first page.

3. The method of claim 1, wherein
the first direction is horizontal direction relative to the display screen, and the second direction is vertical direction relative to the display screen; or
the first direction is right or left direction relative to the display screen, and the second direction is up or down direction relative to the display screen.

4. The method of claim 1, wherein
the first page is one of a plurality of main pages which can be presented interchangeably in the first direction on the display screen;
the second page is one of the plurality of main pages; and
the third page is a subpage of the second page, wherein the second page and its subpages can be presented interchangeably in the second direction on the display screen.

5. The method of claim 4, wherein the second page and its subpages can be presented cyclically in the second direction on the display screen.

6. The method of claim 4, wherein the switching from presentation of the second page to presentation of the third page is performed in a continuous scrolling mode or in a page by page switching mode.

7. The method of claim 4, further comprising:
locking switching from presentation of the first page to presentation of a subpage of the first page.

8. The method of claim 7, wherein the locking comprises:
presenting a password query interface after receiving on the first page an input indicating a page moving in the second direction; and
switching from presentation of the first page to presentation of a subpage of the first page after receiving a correct password.

9. The method of claim 7, wherein the locking comprises:
switching from presentation of the first page to presentation of a subpage of the first page after receiving a special gesture input on the first page; and/or
not switching from presentation of the first page to presentation of a subpage of the first page after receiving on the first page a gesture input which generally indicates a page moving in the second direction.

10. The method of claim 7, wherein the locking comprises:
disabling switching from presentation of the first page to presentation of a subpage of the first page; or
disabling switching from presentation of the first page to presentation of a subpage of the first page during a specific time period and/or at a specific location.

11. The method of claim 1, further comprising
presenting small representations of all pages, wherein the small representations are arranged in the first and second directions;
receiving a selection of one of the small representations; and
presenting a page corresponding to the selected small representation on the display screen.

12. The method of claim 1, further comprising
performing at least one of the following based on user input:
entering an editing mode for pages;
changing position of a page among pages;
adding a page among pages;
adding a main page in the first direction;
adding a subpage of a main page in the second direction;
changing position of a subpage of a main page among subpages of the main page;
changing position of a subpage of a main page to a position among subpages of another main page; and
changing position of a main page among a plurality of main pages, wherein positions of subpages of the main page are changed together with the main page.

13. An apparatus for page navigation in a launcher, comprising:
a presenting module for presenting a first page on a display screen; and
a receiving module for receiving a first input on the first page, wherein the first input indicates a page moving in a first direction;
wherein the presenting module is further for switching from presentation of the first page to presentation of a second page;
wherein the receiving module is further for receiving a second input on the second page, wherein the second input indicates a page moving in a second direction, wherein the second direction is not collinear to the first direction; and
wherein the presenting module is further for switching from presentation of the second page to presentation of a third page.

14. The apparatus of claim 13, wherein
the receiving module is further for receiving a third input on the third page, wherein the third input indicates a page moving in a third direction, wherein the third direction is not collinear to either of the first direction and the second direction; and
the presenting module is further for switching from presentation of the third page to presentation of a fourth page, wherein the fourth page is the first page or the fourth page is not the first page.

15. The apparatus of claim 13, wherein
the first direction is horizontal direction relative to the display screen, and the second direction is vertical direction relative to the display screen; or
the first direction is right or left direction relative to the display screen, and the second direction is up or down direction relative to the display screen.

16. The apparatus of claim 13, wherein
the first page is one of a plurality of main pages which can be presented interchangeably in the first direction on the display screen;
the second page is one of the plurality of main pages; and
the third page is a subpage of the second page, wherein the second page and its subpages can be presented interchangeably in the second direction on the display screen.

17. The apparatus of claim 16, wherein the second page and its subpages can be presented cyclically in the second direction on the display screen.

18. The apparatus of claim 16, further comprising:
a locking module for locking switching from presentation of the first page to presentation of a subpage of the first page.

19. The apparatus of claim 18, wherein
the locking module is further for querying a password after an input indicating a page moving in the second direction is received on the first page; and
the presenting module is further for switching from presentation of the first page to presentation of a subpage of the first page after a correct password is received.

20. A computing system, comprising:
one or more processors for executing machine-executable instructions to run a launcher;
a displayer for displaying a user interface (UI) of the launcher, the UI includes a plurality of pages that can be interchangeably presented on the displayer; and
an input unit for receiving a user input via the UI;
the one or more processors are further for executing machine-executable instructions to:
present a first page on the displayer;
receive a first input on the first page, wherein the first input indicates a page moving in a first direction;
switch from presentation of the first page to presentation of a second page;
receive a second input on the second page, wherein the second input indicates a page moving in a second direction, wherein the second direction is not collinear to the first direction; and
switch from presentation of the second page to presentation of a third page.
